(19) United States
(12) Patent Application Publication
(10) Pub. No.: US 2006/0288051 A1
(43) Pub. Date: Dec. 21, 2006

(54) Methods and apparatuses for ensuring file integrity

(76) Inventor: Geoffrey Levand, Mountain View, CA (US)

Correspondence Address: Richard H. Butler, 5655 Silver Creek Valley Road, #106, San Jose, CA, 95138, US

(21) Appl. No.: 11/153,960

(22) Filed: Jun. 15, 2005

(51) Int. Cl. G06F 17/30

(52) U.S. Cl. 707/203

(57) ABSTRACT

In one embodiment, the methods and apparatuses detect a file and a page corresponding to the file; detect a first saved check file value associated with the file and a second saved check file value associated with the page; calculate a first derived check file value from the file; compare the first saved check file value with the first derived check value; and verify an integrity of the file based on a match between the first saved check file value and the first derived check value.

### FIELD OF INVENTION

The present invention relates generally to ensuring file integrity and, more particularly, to ensuring program and data integrity.

### BACKGROUND

There has been a proliferation of computer use both for personal use and business use. Whether the computer is utilized for business or personal use, there has also been an increase in the amount of data utilized by computers. For example, data utilized by computers includes text documents, graphics, pictures, audio tracks, and video segments.

As the amount of data utilized by computers increases, there is an increased threat against the integrity of the data. There are external threats such as viruses and computer hackers that can compromise the integrity of the data. There are also internal threats to the integrity of the data such as accidental corruption of the data through a defective application and user error.

Early detection of corrupted data is important to prevent further damage to the data from occurring. For example, it is important to detect the initial damage to the data from a computer virus before the computer virus corrupts all the data on the user's computer.

In some instances, merely archiving or backing up the data is not sufficient to prevent the data from being damaged or corrupted. By archiving or backing up the data, the integrity of the data is not confirmed and archiving damaged or corrupted data does not necessarily help preserve the usability of the data.

### SUMMARY

In one embodiment, the methods and apparatuses detect a file and a page corresponding to the file; detect a first saved check file value associated with the file and a second saved check file value associated with the page; calculate a first derived check file value from the file; compare the first saved check file value with the first derived check value; and verify an integrity of the file based on a match between the first saved check file value and the first derived check value.

### BRIEF DESCRIPTION OF THE DRAWINGS

The accompanying drawings, which are incorporated in and constitute a part of this specification, illustrate and explain one embodiment of the methods and apparatuses for ensuring file integrity. In the drawings,

FIG. 1 is a diagram illustrating an environment within which the methods and apparatuses for ensuring file integrity are implemented;

FIG. 2 is a simplified block diagram illustrating one embodiment in which the methods and apparatuses for ensuring file integrity are implemented;

FIG. 3 is a simplified block diagram illustrating a system, consistent with one embodiment of the methods and apparatuses for ensuring file integrity;

FIGS. 4A and 4B are exemplary records for use with the methods and apparatuses for ensuring file integrity;

FIGS. 5A and 5B are exemplary tables for use with the methods and apparatuses for ensuring file integrity;

FIG. 6 is a flow diagram consistent with one embodiment of the methods and apparatuses for ensuring file integrity;

FIG. 7 is a flow diagram consistent with one embodiment of the methods and apparatuses for ensuring file integrity; and

FIG. 8 is an exemplary table for use with the methods and apparatuses for ensuring file integrity.

### DETAILED DESCRIPTION

The following detailed description of the methods and apparatuses for ensuring file integrity refers to the accompanying drawings. The detailed description is not intended to limit the methods and apparatuses for ensuring file integrity. Instead, the scope of the methods and apparatuses for ensuring file integrity are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, and a device capable of receiving/transmitting an electronic message.

References to a “program file” include a file that contains application information that may be utilized by the device to perform functions.

References to a “data file” include a file that contains data. In one embodiment, the data is utilized by the program file. In one embodiment, the data includes text documents, graphics, photographs, audio clips, video clips, and the like.

References to a “file” include an element that includes content from a data file and/or a program file.

In one embodiment, the methods and apparatuses for ensuring file integrity increases the assurance of the data by checking the data for corruption and damage.

In one embodiment, the methods and apparatuses for ensuring file integrity utilize an at once integrity check. In this embodiment, the entire data file is examined before the data file is utilized by the device. By checking the entire data file prior to utilizing the data file, the integrity of the entire data file may be ascertained prior to relying on the data within the data file.

In one embodiment, the methods and apparatuses for ensuring file integrity utilize an on-demand integrity check. In this embodiment, the entire data file is partitioned into separate pages. In one embodiment, each page is separately checked for data integrity prior to use by the device. In one embodiment, only the needed page is checked prior to use and all pages that comprise the data file are not necessary checked for integrity.

In one embodiment, a combination of both the on-demand and the at-once data integrity check are utilized.

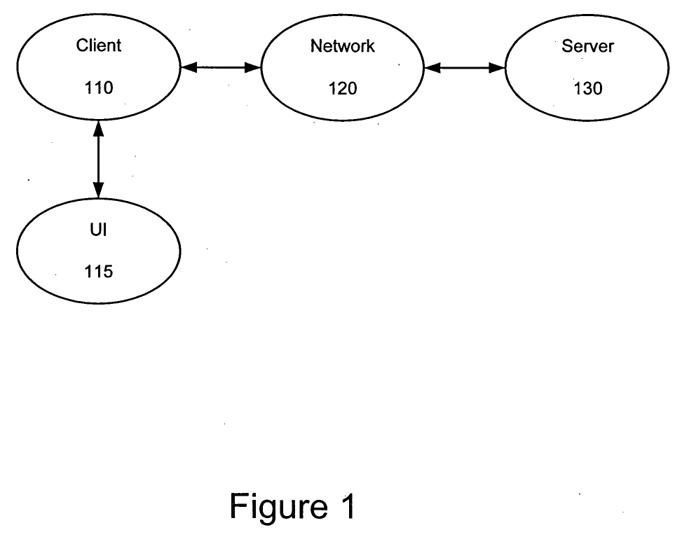

FIG. 1 is a diagram illustrating an environment within which the methods and apparatuses for ensuring file integrity are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of ensuring file integrity related to an event below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

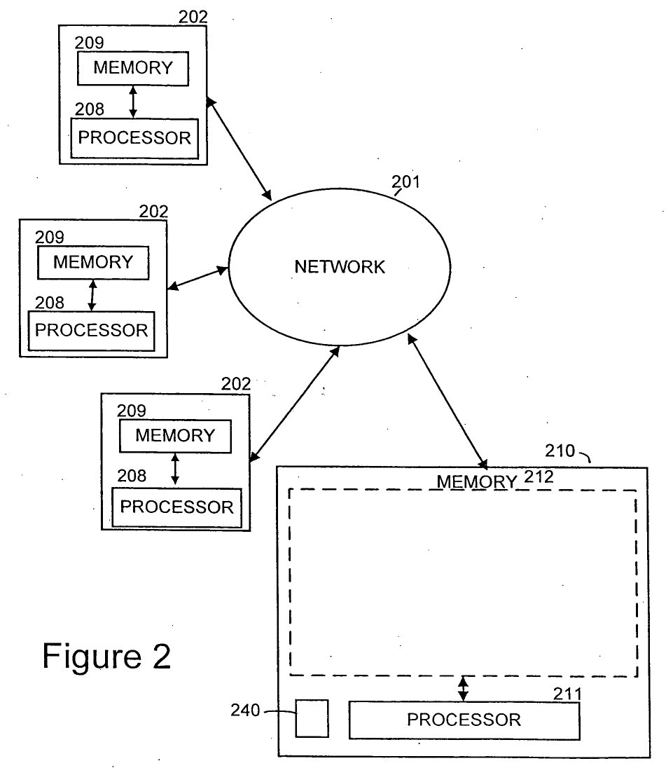

FIG. 2 is a simplified diagram illustrating an exemplary architecture in which the methods and apparatuses for ensuring file integrity are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for ensuring file integrity. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on ensuring file integrity as determined using embodiments described below.

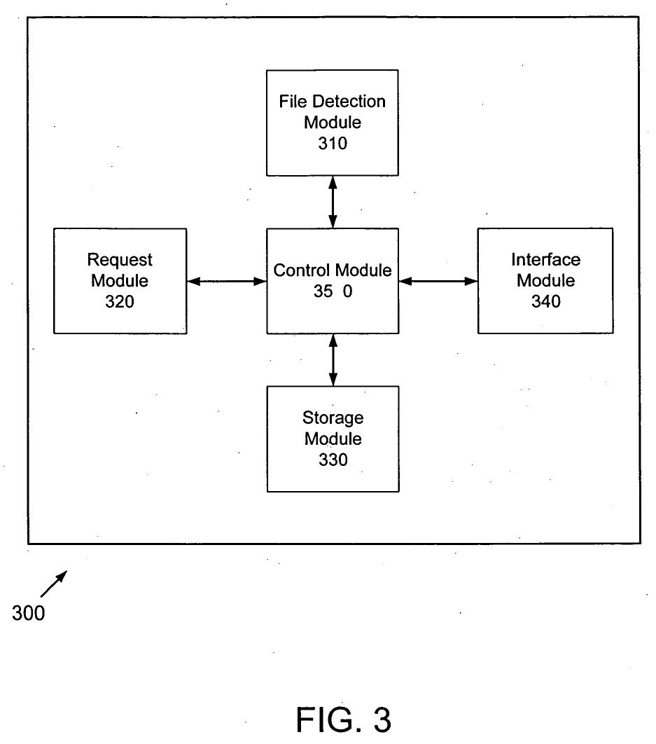

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a file detection module 310, a request module 320, a storage module 330, an interface module 340, and a control module 350.

In one embodiment, the control module 350 communicates with the file detection module 310, the request module 320, the storage module 330, and the interface module 340. In one embodiment, the control module 350 coordinates tasks, requests, and communications between the file detection module 310, the request module 320, the storage module 330, and the interface module 340.

In one embodiment, the file detection module 310 detects a file. In one embodiment, the file detection module 310 partitions the file into separate pages. In one example, the data within the file is separated into 10 separate pages. In this example, page 1 is loaded into memory and utilized by the device before page 2. The device may only utilize page 1 of the data file. Despite the formation of pages 2-10, pages 2-10 may not be utilized by the device.

In one embodiment, the file is a data file. In another embodiment, the file is a program file. In yet another embodiment, the file contains both data content and program content.

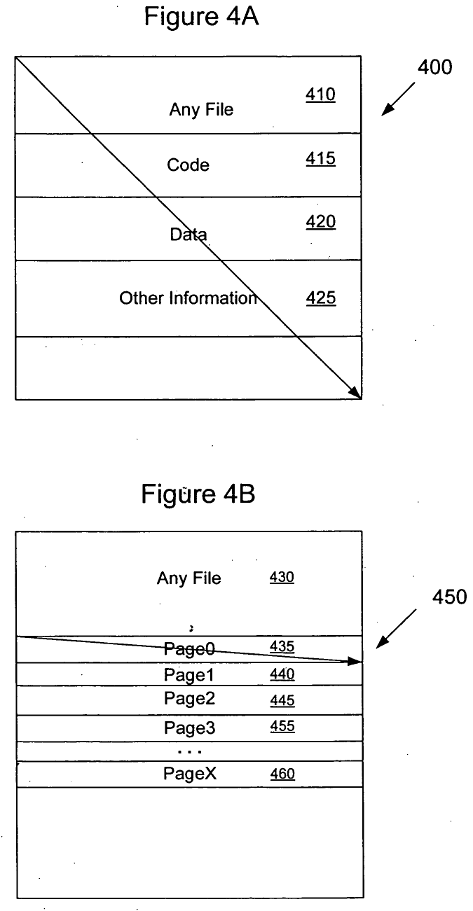

In another embodiment, the file detection module 310 retains the file structure of the file. In one embodiment, exemplary data files are shown in FIGS. 4A and 4B. FIG. 4A illustrates a file that is not distinguished by separate pages. FIG. 4B illustrates a file that includes data that is separated into separate pages.

In one embodiment, the request module 320 selectively performs authentication checks to ensure the integrity of the data files and program files. In one embodiment, the request module 320 utilizes an at-once verification. At-once verification checks the entire file prior to allowing the device to utilize the file. In one embodiment, a saved file check value is assigned to the particular file and is matched against a derived file check value. If the saved file check value and the derived file check value match, then the contents of the file are verified as being intact.

In another embodiment, the request module 320 utilizes an on-demand verification. On-demand verification utilizes files that are partitioned into separate pages. In one embodiment, the request module 320 checks each page prior to the page being utilized by the device. Similar to the at-once verification, the saved file check and the derived file check values are matched for each particular page.

In one embodiment, the storage module 330 stores a record including the saved file check values and the files. In one embodiment, the files containing data are stored within the storage module 330. In another embodiment, the files containing an application are stored within the storage module 330. In one embodiment, the file stored within the storage module 330 is partitioned into separate pages. FIGS. 4A and 4B include exemplary records showing files stored within the storage module 330.

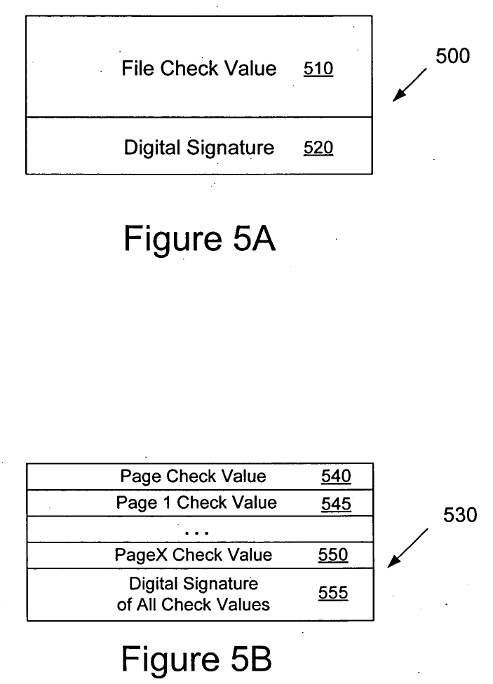

In one embodiment, the saved file check values are stored within a table as illustrated in FIGS. 5A and 5B.

In one embodiment, the interface module 340 receives a signal from one of the electronic devices 110 and indicates a request to utilize a file is received by the system 300. In another embodiment, the interface module 340 delivers a signal to one of the electronic devices 110 indicating that the file retains its integrity. In yet another embodiment, the interface module 340 delivers a signal to one of the electronic devices 110 indicating that the file is corrupted or damaged.

The system 300 in FIG. 3 is shown for exemplary purposes and is merely one embodiment of the methods and apparatuses for ensuring file integrity. Additional modules may be added to the system 300 without departing from the scope of the methods and apparatuses for ensuring file integrity. Similarly, modules may be combined or deleted without departing from the scope of the methods and apparatuses for ensuring file integrity.

FIG. 4A illustrates an exemplary record 400 that represents a file 410 that is formatted to be checked by the at-once verification. In one embodiment, each record 400 represents a separate file. In one embodiment, the file 410 is a data file. In another embodiment, the file 410 is an application file. In yet another embodiment, the file 410 is both a data file and an application file. In one embodiment, the file 410 includes code 415, data 420, and other information 425.

FIG. 4B illustrates an exemplary record 450 that represents a file 430 that is formatted to be checked by the on-demand verification. In one embodiment, each record 450 represents a separate file. In one embodiment, the file 450 is a data file. In another embodiment, the file 450 is an application file. In yet another embodiment, the file 450 is both a data file and an application file. In one embodiment, the file 450 includes a first page 435, a second page 440, a third page 445, a fourth page 455, and an X page 460. In one embodiment, the first page 435 through X page 460 are partitioned from the file 450 and represent the entire file 450.

FIG. 5A illustrates an exemplary table 500 that includes a saved check value 510 and a digital signature 520 that corresponds to a single file. In one embodiment, the saved check value 510 and the digital signature 520 correspond to the file 410 within the record 400. For example, the saved check value 510 is formed by analyzing the contents within the file 410. In one embodiment, the digital signature 520 corresponds with the saved check value 510. In another embodiment, the digital signature 520 corresponds to a file.

FIG. 5B illustrates an exemplary table 550 that includes a first saved file check value 540, a second saved file check value 545, an X saved file check value 550, and a digital signature 555. In one embodiment, the first saved file check value 540, the second saved file check value 545, the X saved file check value 550, and the digital signature 555 correspond to the file 430 within the record 450. For example, the first saved file check value 540 corresponds to the first page 435; the second saved file check value 545 corresponds to the second page 440; and the X saved file check value corresponds to the X page 460.

In one embodiment, during the at-once verification, the saved file check value associated with the file 410 that is located within the table 500 is checked against the derived file check value that is calculated from the file 410. If the saved file check value and the derived file check value match, then the file 410 is verified as intact and valid. Otherwise, if the saved file check value and the derived file check value do not match, then the file 410 may be corrupted or damaged.

In one embodiment, during the on-demand verification, a page within the file 430 is requested for utilization by the device. Prior to supplying this particular page, the saved file check value associated the particular page within the file 430 that is located within the table 530. Further, the derived file check value is formed from the particular page within the file 430. In one embodiment, the saved file check value is checked against the derived file check value. If the saved file check value and the derived file check value match, then the particular page within the file 430 is verified as intact and valid. Otherwise, if the saved file check value and the derived file check value do not match, then the particular page within the file 430 may be corrupted or damaged.

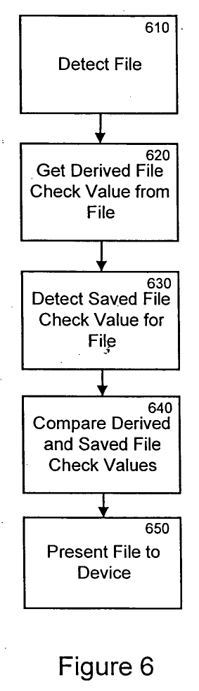

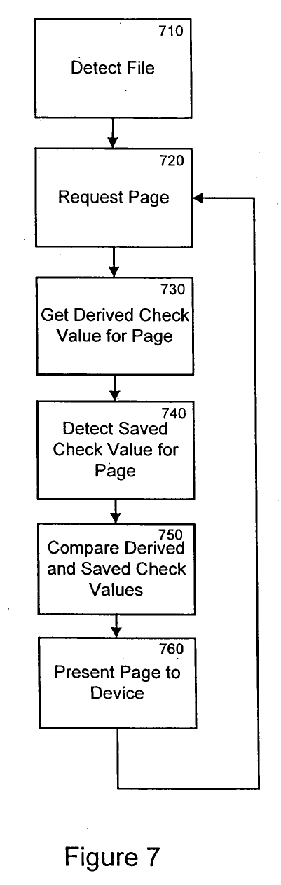

The flow diagrams as depicted in FIGS. 6 and 7 are one embodiment of the methods and apparatuses for ensuring file integrity. The blocks within the flow diagrams can be performed in a different sequence without departing from the spirit of the methods and apparatuses for ensuring file integrity. Further, blocks can be deleted, added, or combined without departing from the spirit of the methods and apparatuses for ensuring file integrity.

The flow diagram in FIG. 6 illustrates utilizing at-once verification according to one embodiment of the invention.

In Block 610, a file is detected. In one embodiment, the file is selected to be utilized by a device. In one embodiment, the file is a data file. In another embodiment, the file is an application file. In yet another embodiment, the file is both a data file and an application file.

In Block 620, a derived file check value is obtained for the file. In one embodiment, the file as detected in the Block 610 is analyzed and the derived file check value is calculated from analyzing the file.

In Block 630, a saved file check value is detected. In one embodiment, the saved file check value is stored within the storage module 330. An exemplary record for storing the saved file check value is shown in FIG. 5A.

In one embodiment, the saved file check value is generated at a prior time when the file was analyzed prior to being requested.

In Block 640, the derived file check value and the saved file check value are compared.

In Block 650, the file is presented to the device if the derived file check value matches the saved file check value for the file as selected in the Block 610. In one embodiment, if the derived file check value matches the saved file check value, then the integrity of the file has been maintained. For example, by having these values match, the file has not changed between the time the file was analyzed to generated the saved file check value. In another embodiment, the derived check value may correspond with the saved file check value without exactly having the values exactly match.

In one embodiment, the digital signature 520 helps in verifying the authenticity of the saved file check value 510 stored within the record 500.

The flow diagram in FIG. 7 illustrates utilizing an on-demand verification according to one embodiment of the invention.

In Block 710, a file is detected. In one embodiment, the file is selected to be utilized by a device. In one embodiment, the file is a data file. In another embodiment, the file is an application file. In yet another embodiment, the file is both a data file and an application file. In one embodiment, the file is partitioned into separate pages.

In Block 720, the device requests a specific page that is part of the file.

In Block 730, a derived file check value is obtained for the specific, requested page. In one embodiment, the specific page as requested in the Block 720 is analyzed and the derived file check value is calculated from analyzing the specific page.

In Block 740, a saved file check value is detected. In one embodiment, the saved file check value is stored within the storage module 330. An exemplary record for storing the saved file check value is shown in FIG. 5B.

In one embodiment, the saved file check value is generated at a prior time when the specific page was analyzed prior to being requested.

In Block 750, the derived file check value and the saved file check value are compared.

In Block 760, the specific page is presented to the device if the derived file check value matches the saved file check value for the specific page as requested in the Block 720. In one embodiment, if the derived file check value matches the saved file check value, then the integrity of the specific page has been maintained. For example, by having these values match, the specific page has not changed between the time the page was analyzed to generated the saved file check value.

In one embodiment, the digital signature 555 helps in verifying the authenticity of the saved file check value stored within the record 500. In one embodiment, additional pages can be requested in the Block 720.

In one embodiment, the on-demand verification is utilized in conjunction with the at-once verification. By utilizing both on-demand and at-once verification, different performance and speed goals can be achieved by selecting the level of assurance for each of these verifications. By increasing the assurance level that the file or page is free from corruption, the speed of the file or page check may slow.

For example, by choosing a more thorough examination through at-once verification and a more cursory examination through on-demand verification, the file will experience a slightly longer initial delay up start up use. However, with stronger at-once verification and more cursory on-demand verification, delays during use of the file may be minimized. Likewise, weaker at-once verification and stronger on-demand verification, delays at the initial access of the file during a particular session may be minimized and ongoing use of the file may experience slightly longer delays.

In another example, both the at-once and on-demand verification can be strengthened to provide a higher level of assurance. However, performance speed of the initial file and use of the file may be delayed. Similarly, both the at-once and on-demand verification can be weakened to provide a lower level of assurance and speed of the initial file use and ongoing use may be faster.

In one embodiment, the at-once and on-demand verification can provide error correction to the system 300. In one embodiment, the saved check file values are extended to include error correction values.

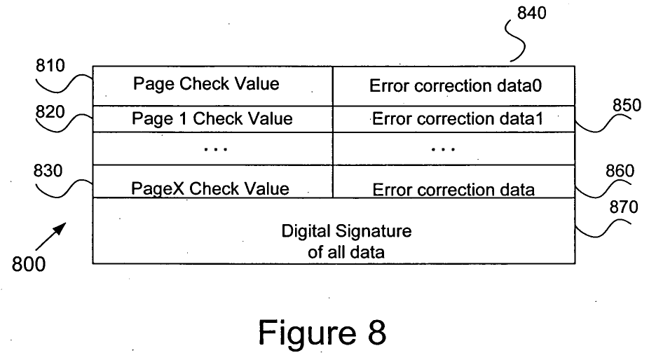

For example, FIG. 8 shows an exemplary table 800 that illustrates an on-demand verification with error correction. Table 800 includes a first saved file check value 810, a second page saved file check value 820, an X page saved file check value 830, a first page error correction value 840, a second page error correction value 850, an X page error correction value 860, and a digital signature 870. In one embodiment, the first saved file check value 810 corresponds to the first page error correction value 840; the second page saved file check value 820 corresponds to the second page error correction value 850; and the X page saved file check value 830 corresponds to the X page error correction value 860.

In one embodiment, the at-once verification ensures that the file is not corrupted or damaged at the initial access of the file during a particular session. Further, the on-demand verification detects errors while the file is in use and also provides error correction.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
detecting a file and a page corresponding to the file;
detecting a first saved check file value associated with the file and a second saved check file value associated with the page;
calculating a first derived check file value from the file;
comparing the first saved check file value with the first derived check value; and
verifying an integrity of the file based on a match between the first saved check file value and the first derived check value.

2. The method according to claim 1 further comprising presenting the file to a device based on the integrity of the file.

3. The method according to claim 1 further comprising storing the file within a storage module.

4. The method according to claim 1 further comprising storing the first saved check file value within a storage module.

5. The method according to claim 1 further comprising storing the second saved check file value within a storage module.

6. The method according to claim 1 wherein the file has the integrity if the first saved check file value matches the first derived check value.

7. The method according to claim 1 further comprising allowing access to the file by a device after the first saved check file value matches the first derived check value.

8. The method according to claim 1 wherein the file is a program file.

9. The method according to claim 1 wherein the file is a data file.

10. The method according to claim 1 wherein the file contains program information and data information.

11. The method according to claim 1 wherein calculating the first derived check file value further comprises reviewing the file to determine the first derived check file value.

12. The method according to claim 1 further comprising calculating the second derived check file value from the page.

13. The method according to claim 12 further comprising comparing the second saved check file value with the second derived check file value.

14. The method according to claim 12 further comprising verifying a page integrity associated with the page, based on a match between the second saved check file value and the second derived check file value

15. The method according to claim 14 further comprising presenting the page to a device based on the page integrity.

16. The method according to claim 14 further comprising:
presenting the file to the device based on the file integrity; and
presenting the page to the device based on the page integrity.

17. The method according to claim 16 wherein the page is presented after the file is presented.

18. The method according to claim 1 further comprising verifying an authenticity of the first saved check file value based on a digital signature.

19. The method according to claim 1 further comprising verifying an authenticity of the second saved check file value based on a digital signature.

20. A system comprising:
means for detecting a file and a page corresponding to the file;
means for detecting a first saved check file value associated with the file and a second saved check file value associated with the page;
means for calculating a first derived check file value from the file;
means for comparing the first saved check file value with the first derived check value; and
means for verifying an integrity of the file based on a match between the first saved check file value and the first derived check value.

21. A system, comprising:
a storage module to store a saved check file value;
a file detection module to detect a file and a derived check file value based on the file; and
a request module to selectively compare the saved check file value with the derived check file value.

22. The system according to claim 21 further comprising an interface module configured to select the file.

23. The system according to claim 21 wherein the derived check file value and the saved check file value correspond to a page within the file.

24. The system according to claim 23 further comprising an interface module configured to select the page.

25. A computer-readable medium having computer executable instructions for performing a method comprising:
detecting a file and a page corresponding to the file;
detecting a first saved check file value associated with the file and a second saved check file value associated with the page;
calculating a first derived check file value from the file;
comparing the first saved check file value with the first derived check value; and
verifying an integrity of the file based on a match between the first saved check file value and the first derived check value.
